(19) United States
(12) Patent Application Publication
(10) Pub. No.: US 2026/0121323 A1
(43) Pub. Date: Apr. 30, 2026

(54) MODULAR POWER TRANSFER BOARD

(71) Applicant: HEWLETT PACKARD ENTERPRISE DEVELOPMENT LP, Spring, TX (US)

(72) Inventors: Kuan-Wei Chen, Taipei City (TW); Chih-Wei Chiang, Taoyuan City (TW); Peng Chianghsieh, Taoyuan City (TW)

(21) Appl. No.: 18/929,870

(22) Filed: Oct. 29, 2024

(51) Int. Cl. H01R 12/72; G06F 1/18; H01R 12/75

(52) U.S. Cl. CPC H01R 12/725; G06F 1/184; G06F 1/188; G06F 1/189; H01R 12/75

(57) ABSTRACT

A modular power transfer board, a system and a method. The modular power transfer board comprising a first side comprising a first edge connector socket and a second side comprising a second edge connector socket, wherein the wherein the first edge connector socket and the second edge connector socket are electrically connected to each other, and wherein in a first configuration, the first edge connector socket is configured to connect to a power supply unit (PSU) edge connector of a PSU and the second edge connector socket is configured to connect to a board edge connector of a primary system board, and in a second configuration, the first edge connector socket is configured to connect to the board edge connector of the primary system board and the second edge connector socket is configured to connect to the PSU edge connector of the PSU.

### INTRODUCTION

In enterprise information processing systems (e.g., servers), the power supply units (PSUs) of the system often utilize an PCB edge-connector to connect to the primary system board of the system, with the system generally having one or more compatible sockets to receive the edge connectors of such PSUs. The sockets to receive the PSU edge connectors may be referred to herein as edge connector sockets. In some cases, the edge connector sockets are mounted to the primary system board, whereas in other cases the edge connector sockets may be connected to an intermediate board, referred to as a power distribution board (PDB), which is in turn connected to the primary system board. For example, computing systems that utilize the Open Compute Project (OCP) modular hardware system generally include PSUs with edge connectors which comply with OCP specifications, with such PSUs generally being referred to as modular common redundant power supplies (M-CRPS) (also referred to herein interchangeably as PSUs). In such computing systems, the complementary edge connector sockets on the primary system board or on a PDB are also compliant with the OCP modular hardware system. The aforementioned PSU edge connectors and the complimentary edge connector sockets come in a variety of form factors (e.g., different sizes).

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operation. In the drawings:

FIG. 1 is a block diagram illustrating an example of a modular power transfer board installed in an example information processing device, in a first configuration where a PSU edge connector of a PSU is connected to a first side of the modular power transfer board and the second side of the modular power transfer board is connected to a primary system board.

FIG. 2 is a block diagram illustrating the modular power transfer board of FIG. 1 installed in another example of an information processing device, in a second configuration where the PSU edge connector of a PSU is connected to the second side and the first side is connected to the primary system board.

FIG. 3A is a perspective view of a first side of an example modular power transfer board.

FIG. 3B is a perspective view of a second side of the modular power transfer board of FIG. 3A.

FIG. 4 is a perspective view of the modular power transfer board of FIGS. 3A-3B, with the first side thereof connected with edge connector power cables and sideband cables and with the second side thereof connected to two power supply units.

FIG. 5 is a perspective view of the board of FIGS. 3A-3B, with the first side thereof connected to two power supply units.

FIG. 6 is a top view of an example system with power supply units connected to a primary system board using a modular power transfer board.

The drawings are included to provide a further understanding of the present disclosure and are incorporated in and constitute a part of this specification. The drawings illustrate one or more examples of the present teachings and together with the description explain certain principles and operations. In some occasions, details that are not necessary for an understanding of an instance of this disclosure or that render other details difficult to perceive may have been omitted.

### DETAILED DESCRIPTION

Different systems (or system configurations) may utilize different form factors of PSU. The type of PSU that is used may be selected based on desired performance, space constraints, or other factors. These different form factors of PSUs may have different edge connector form factors. Therefore in systems that utilize PDBs, different types of PDBs which have different form factors of edge connector sockets may be needed depending on which type of PSU edge connectors are present. For example, one system may have a particular chassis, a particular primary system board, and a particular arrangement of PSUs, and thus may use a certain type of PDB which is compatible with this configuration, whereas another configuration may have the same chassis, but different primary system board, and/or different PSU arrangement, and thus it may need a different PDB which is compatible with its different configuration.

One reason that different systems may use different PSU form factors, and thus require different PDBs, is that the systems may have different space constraints. For example, suppose that two systems both have 19-inch-wide chassis, but that one system utilizes a 250 mm wide primary system board (e.g., a Class B M-SDNO Host Processor Module (HPM)) while the other system utilizes a 295 mm wide primary system board (e.g., an M-SDNO Type 4 HPM). Suppose further that the systems are designed to have two M-CRPS disposed in the space between the primary system board and a side wall of the chassis. In the second system with the 250 mm system board, there may be sufficient space between the system board and the side wall to receive two 73.5 mm M-CRPS. On the other hand, in the second system with the 295 mm system board, there is insufficient space to receive two 73.5 mm M-CRPS and therefore two 60 mm M-CRPS need to be used instead. Consequently, a first PDB with 73.5 mm edge connector sockets may be needed with the first system and a second PDB with 60 mm edge connector sockets may be needed for the second system.

Consequently, a system manufacturer may need to design, produce, and handle multiple different types of PDB for different system configurations. This can drive-up development costs, as engineers may need to spend time designing multiple different PDBs. Furthermore, this can increase manufacturing costs, as different manufacturing lines or equipment may be needed to manufacture the different PDBs. Also, this can increase logistical costs, as each PDB may need its own stock-keeping unit (SKU) or part number, which complicates warehousing, shipping, and other logistics. Having multiple types of PDB also increases the complexity of assembling the systems, as assembly personnel need to select the correct PDB from among multiple PDBs when assembling the system. Upgrading or reconfiguration of a system after manufacture by changing the type of PSU used therein is also made more difficult, as a user may need to obtain a new type of PDB in order to change their PSU.

To address the above-mentioned challenges, the disclosure provides a modular power transfer board that can connect interchangeably to different form factors of PSU edge connector. This allows for the same power transfer board to be used in different systems which utilize different types of PSUs. The modular power transfer board is a doubled sided printed circuit assembly (PCA) that includes connectors on both sides. More specifically, the PCA comprises one or more first edge connector sockets one a first side thereof and one or more second edge connector sockets on a second side thereof. The first edge connector sockets are compatible with (i.e., configured to mate with) a first form factor of PSU edge connector, whereas the second edge connector sockets are compatible with (i.e., configured to mate with) a second form factor of PSU edge connector. These first and second edge connector sockets are electrically connected to one another via internal circuitry of the PCB, such that electrical power input to the first edge connector sockets can be output via the second edge connectors sockets, and vice versa.

The modular power transfer board can thus be deployed in at least two different configurations using different types of PSU. In a first configuration, one or more first PSUs having an edge connector with the first form factor is (are) mated to one or more of the first edge connector sockets on the first side, and a first cable having an edge connector with the second form factor is connected to one or more of the second edge connector sockets on the second side. On the other hand, in a second configuration one or more second PSUs having an edge connector with the second form factor is (are) mated to one or more of the second edge connector sockets on the second side, and a second cable having an edge connector with the first form factor is connected to one or more of the first edge connector sockets on the first side. In both configurations, the end of the cables not connected to the modular power transfer board can be connected to other components in the system including the primary system board, and thus the first or second PSUs are electrically connected to the system board via the modular power transfer board and the cables.

Because the same modular power transfer board can be used in different system configurations with different types of PSUs, there is no need to design and produce multiple different PDBs for these different systems. Thus, development, manufacturing, and logistical costs can be reduced. In addition, it may be easier to upgrade or reconfigure a system post manufacture as a new PDB may not be needed if the type of PSU is changed.

In some examples, the modular power transfer board also includes a notch to provide clearance for the system board in systems with larger sized primary system boards.

In some examples, the modular board also includes secondary power outlets on one side thereof that provide a secondary power output path, in addition to a primary power output path provided via the aforementioned first and second edge connector sockets and the cables connected thereto. In some examples, the secondary power output path may be connected to the primary system board to supplement the power supplied thereto by the primary power output path, allowing the primary system board to receive more power than would be possible with the primary output path alone. In other examples, the secondary power output path may be connected to some other component(s) of the system, such as an expansion card (e.g., a graphics processing unit), storage backplane, fan board, etc.

In examples, the modular power transfer board includes multiple connectors which are all integrated together into a single unit or module. In particular, the modular power transfer board includes the first edge connector socket on one side thereof which mates with the edge connector of a first PSU or with one or more cable connectors of one or more cables, and the second edge connector second on an opposite side thereof which mates with one or more cable connectors of one or more cables or a second PSU. One side of the modular power transfer board also includes a sideband outlet which mates with one or more cable connectors of one or more cables (which connects to sideband socket of a primary system board for PSU management). On one side of the modular power transfer board, secondary power connectors may also be included. These secondary power connectors may have a form factor different than the edge connector sockets. For example, instead of being configured to receive an edge of a PCB, the secondary power connectors may have pins which comprise an array of recesses (barrels, jacks) configured to receive columnar posts of a complementary connector, or an array of columnar posts configured to be inserted into recesses (barrels, jacks) of a complementary connector. As mentioned above, these secondary power connectors may be used to supplement the power output of the edge connector sockets. For example, one side of the modular power transfer board may include a 73.5 mm edge connector, while the other side may include a 60 mm edge connector. In this example, the secondary power connectors can be used to carry the excess power capacity of the 73.5 mm edge connector that goes beyond the capacity of the 60 mm edge connector.

The modular power transfer board also includes a sideband outlet on one of the sides that provides PSU management input and output. This sideband outlet is configured to mate with a connector of a sideband cable, which may be connected to the primary system board. Thus, the PSU may be communicably connected to the primary system board to communicate sideband signals therebetween via the sideband outlet and sideband cable. As used herein, sideband cable may refer to a single cable or a bundle of cables. The sideband outlet, secondary power connector and first and second edge connector sockets (on each side of the modular power transfer board) are permanently attached to the modular power transfer board. For example, the components of the modular power transfer board may be attached to the modular power transfer board, such as by stamping and/or press-fitting.

As noted above, the edge connector sockets and the secondary power outputs can mate with cables, depending on the configuration in which the power transfer board is deployed. These cables may include a connector at one end thereof to mate with the connector of the power transfer board, a second connector at the opposite end thereof, and flexible wires extending therebetween. This second connector may be connected to power connectors of a primary system board, or another device, thereby electrically connecting the modular power transfer board (and the PSU connected thereto) to the primary system board, or other device. For example, one or more cables may supplementally connect the modular power transfer board to the primary system board (e.g., via a Platform Connectivity Power (PICPWR) distribution connector of the system board for a power supplement connection) with such cables being referred to herein as “power cables.” The edge connector cables used for the “main” power output is referred to herein as “edge connector power cables.”

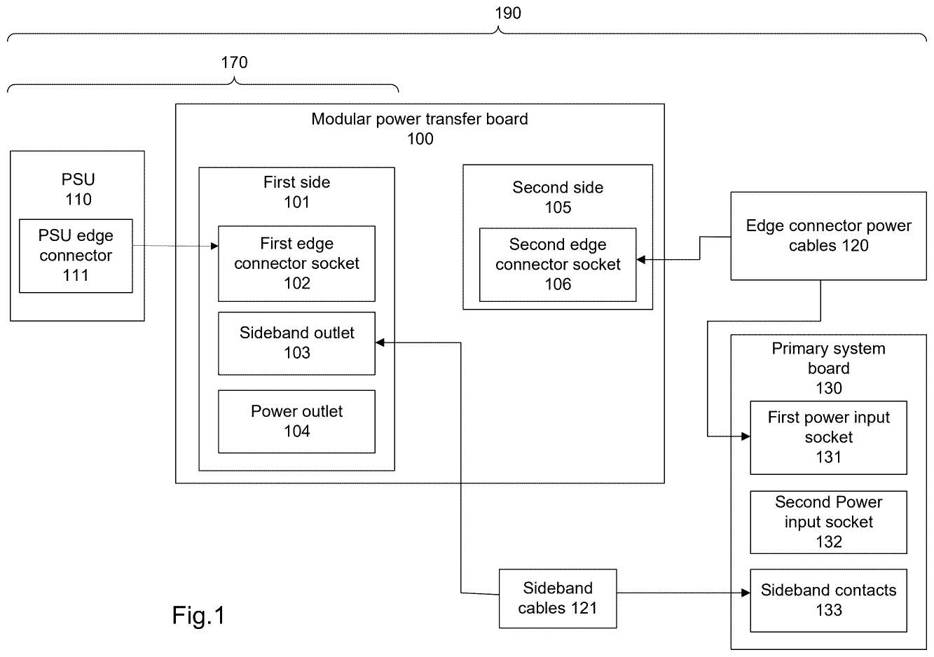

These and other examples will be described in greater detail below in relation to FIGS. 1-6.

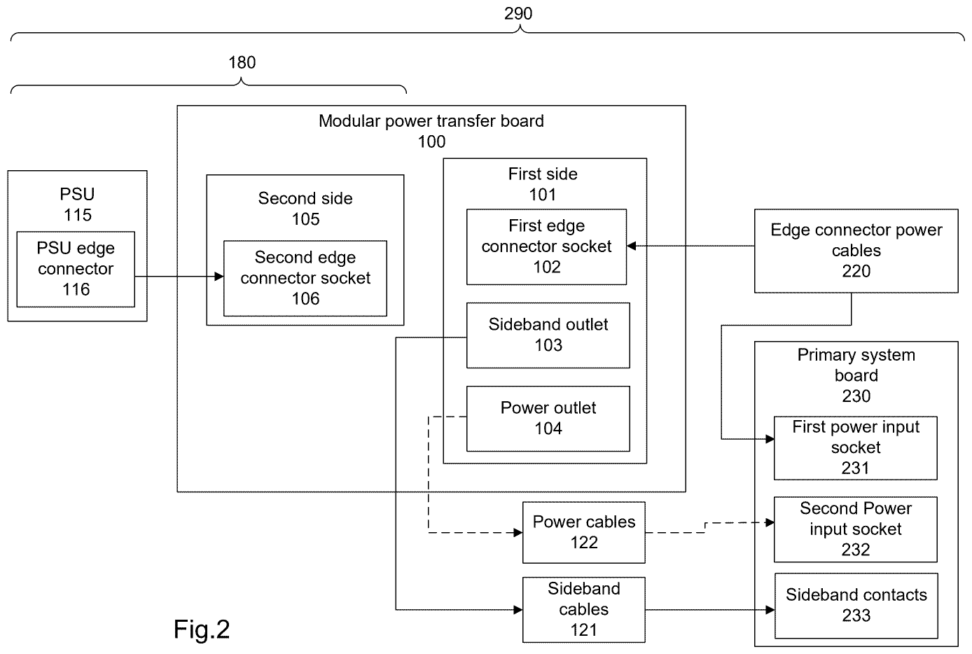

Now referring to FIGS. 1 and 2, a modular power transfer board 100 is presented. FIG. 1 shows the modular power transfer board 100 installed in an information processing device 190 in a first configuration. In addition to the modular power transfer board 100, the information processing device 190 comprises a primary system board 130, and a first PSU 110. Information processing device 190 also includes edge connector power cables 120 and sideband cables 121. FIG. 2 shows the modular power transfer board 100 installed in another information processing device 290 in a second configuration. In addition to the modular power transfer board 100, the information processing device 290 comprises a second primary system board 230, and a second PSU 115. Although modular power transfer board 100 and information processing devices 190/290 are described together herein for ease of understanding, it should be understood that the modular power transfer board 100, the PSU 110/115, the primary system board 130/230, and/or other components of the information processing devices 190/290 may be produced or sold separately or together and may be claimed separately or together herein—in other words, some examples disclosed herein include the modular power transfer board 100 alone, others include the modular power transfer board 100 connected to PSU 110/115 or primary system board 130/230, and still others include the entire information processing device 190/290. FIG. 1 also includes an assembly 170 that includes PSU 110 and first side 101. In FIGS. 1 and 2, some electrical connections between components are indicated by solid and dashed lines extending between the boxes which represent those components, where lines with arrows thereon indicate removable connections (not all connections are necessarily shown).

The modular power transfer board 100 includes a first side 101 and a second side 105. In this context, side refers to the combination of a particular face of a PCB (not illustrated) of the modular power transfer board 100 together with the components mounted to that face. Thus, the first side 101 refers to a first face of the PCB together with components mounted to that first face, while second side 105 refers to a second face of the PCB, opposite from the first face, together with components mounted to that second face. It should be noted that first and second sides are used for ease of description. The sides may alternatively be referred to as side A and side B, one side and the other side, and so on. In this case, first side 101 includes a first edge connector socket 102, a sideband outlet 103 and a power outlet 104. The second side 105 includes a second edge connector socket 106.

The first edge connector socket 102 and the second edge connector socket 106 are configured to receive edge connectors of corresponding PSUs 110 and 115. As used herein, an edge connector socket is a socket configured to receive and electrically connect with an edge connector, which is an electrical connector formed from the edge of a PCB with pins comprising electrical contact pads arranged along the PCB edge. In instances, first edge connector socket 102 and second edge connector socket 106 are each configured to connect to different form factor PSU edge connectors. More specifically, first edge connector socket 102 is configured to mate with a first form factor of PSU edge connector (such as the edge connector 111 of PSU 110), while second edge connector socket 106 is configured to mate with a second form factor of PSU edge connector (such as the edge connector 116 of PSU 115). For example, the first form factor may be a 60 mm M-CRPS form factor, in which case the first edge connector socket 102 may be a 60 mm M-CRPS socket, while the second form factor may be a 73.5 mm M-CRPS form factor, in which case the second edge connector socket 106 may be a 73.5 mm M-CRPS socket. The first and second edge connector sockets 102 and 106 each comprise electrical contacts configured to engage with complementary electrical contacts of the PSU edge connectors 111/116 which carry power signals, referred to hereinafter as “power pins.” The first and second edge connector sockets 102 and 106 also each comprise electrical contacts configured to engage with complementary electrical contacts of the PSU edge connectors 111/116 which carry side signals, referred to hereinafter as “sideband pins.” Thus, the sockets 102 and 106 are configured to receive power and sideband signals from the PSU 110 or 115 when connected thereto, as explained in more detail below. Although only one first edge connector socket 102 and only one second edge connector socket 106 are illustrated, modular power transfer board 100 may include multiple first and second edge connector sockets 102/106. For example, the first side 101 may include two first edge connector sockets 102, while the second side 105 may include two second edge connector sockets 106. Similarly, first side 101 may include multiple secondary power outlets 104.

The sideband outlet 103 is configured to receive a sideband connector. More specifically, the sideband outlet 103 is configured to carry sideband signals and thus has sideband pins which are electrically connected to sideband pins of the first edge connector socket 102 and to sideband pins of the second edge connector socket 106.

The secondary power outlet 104 is configured to receive a secondary power connector of a secondary power cable. The secondary power outlet 104 has power pins electrically connected to the power pins of the first edge connector socket 102, and therefore power signals received by the socket 102 from PSU 110 can be conveyed to the secondary power outlet 104. Thus, in some examples, the power supplied to first edge connector socket 102 may be divided (shared) between the second edge connector socket 106 and the secondary power outlet 104. In other words, in some examples the second edge connector socket 106 and the secondary power outlet 104 form parallel power output paths. In some examples, the secondary power outlet 104 may have a form factor different than the edge connector sockets. For example, instead of being configured to receive an edge of a PCB, the secondary power outlet 103 may have pins which comprise an array of recesses (barrels, jacks) configured to receive columnar posts of a complementary connector, or an array of columnar posts configured to be inserted into recesses (barrels, jacks) of a complementary connector. In an example, the secondary power outlet 104 may have a form factor as specified in the Modular Hardware System-Platform Infrastructure Connectivity (M-PIC) specification—for example, the secondary power outlet 104 may be a vertical PICPWR header.

The PSU 110 includes a PSU edge connector 111 having the first form factor. In the configuration illustrated in FIG. 1, PSU edge connector 111 connects to the first edge connector socket 102. As it will be understood by one or ordinary skill in the art, the first edge connector socket 102 is configured to receive power signals, which may include supply (e.g., positive) voltage signals and ground voltage signals, from pins, or fingers, included in the PSU edge connector 111. It should be noted that although only one PSU 110 is illustrated, multiple may be present, each connected to a respectively corresponding PSU edge connector socket 102 of the modular power transfer board 100. An alternative configuration will be described in reference to FIG. 2 further below.

As mentioned above, information processing device 190 includes the primary system board 130, which is attached to and supported by a chassis. A “system board,” as used in this disclosure, is a central circuit board comprising a central processing unit (CPU) and supporting circuitry, and configured to enable connection and integration among a plurality of components and devices. In examples, primary system board 130 may include an OCP primary board. In an instance, “OCP primary board,” is a primary board configured for OCP form factor. In some instances, a primary board which complies with OCP form factors may be referred to as a Host Processor Module (HPM). The primary system board 130 includes a first power input socket 131 and sideband socket 133. In some examples, primary system board 130 may also include a second power input socket 132, while in other examples this may be omitted. As used herein, the “first power socket” is a standardized connector socket configured to connect with a cabled connector (which may be an edge-style connector in some examples or another style of connector in other examples) to receive input power for the primary system board. The “sideband socket,” as used herein, is a standardized socket used for out-of-band communication with components. As used herein, the “second power input socket” is a standardized socket configured to connect with a cabled connector to receive input power for the primary system board. In instances, the second power input socket 132 may be, or include, a PICPWR distribution connector. In instances, the first power input socket 131 connects to modular power transfer board 100 using the edge connector power cables 120. In the configuration described in reference to FIG. 1, the first power input socket 131 connects to the second edge connector socket 106 through the edge connector power cables 120. The edge connector power cables 120 includes a first side with a connector configured to removably mate with the first power input socket 131 and a second side with an edge connector configured to removably connect, in the configuration of FIG. 1, with second edge connector sockets 106. The edge connector of the second side of the edge connector power cables 120 has the second form factor, and thus is suitable for mating with the second edge connector socket 106. The connector of the first side of the cables 120 may be an edge connector in some examples or another style of connector in other examples, depending on the form factor of the first power input socket 131.

As described above, modular power transfer board 100 may also be used for connecting one or more PSUs to devices other than primary system boards. For example, modular power transfer board 100 may be used to connect to expansion modules, such as a graphic processor unit (GPU), network cards, and the like.

In instances, sideband socket 133 connects to the modular power transfer board 100 using the sideband cables 121. In this configuration, in reference to FIG. 1, the sideband socket 133 connect to the sideband outlet 103 using the sideband cables 121. The sideband cables 121 includes a first connector that removably mates with the sideband socket 133 and a second connector that removably mates with the sideband outlet 103. It should be noted that in this configuration, second power input socket 132 cannot be connected to the modular power transfer board 100 due to physical constraints of this configuration. For example, in this configuration the PSU 110 may physically block access to the power outlet 104 of the modular power transfer board 100. Although the power outlet 104 is blocked by the PSU 110 in this configuration, the sideband outlet 103 is still accessible using the sideband cables 121.

Now referring to FIG. 2, an alternate installation configuration of the modular power transfer board 100 is presented, with the board 100 being installed in for another information processing device 290. This information processing device 290 may have a primary system board 230 which is analogous to the primary system board 130 described above. The primary system board 230 may be the same as the primary system board 130 in some examples. In other examples, the primary system board 230 may differ in form factor (e.g., size) from the primary system board 130 and/or may have different components. The information processing device 290 also comprises a PSU 115, but this PSU 115 may be a different form factor than the PSU 110.

FIG. 2 shows an assembly 180 that includes a PSU 115 connected to the second side 105. In this configuration, the PSU 115 connects to the second side 105, while a primary system board 230 connects to the first side 101. The PSU 115 includes a PSU edge connector 116 having the second form factor. Thus, in this configuration, PSU edge connector 116 connects to second edge connector socket 106, rather than the first edge connector socket 102. Also in this configuration, first power input socket 131 first edge connector socket 102 is connected to the first power input socket 231 of the primary system board 230 through edge connector power cables 220. Thus, a primary power supply path can be established between the PSU 115 and the system board 230 via the second edge connector socket 106 and the edge connector power cables 220. In addition, sideband socket 133 is connected to sideband outlet 103 through sideband cables 121, thus allowing sideband signals to flow between system board 230 and PSU 115. In the configuration of FIG. 2, one side of edge connector power cables 220 has one or more edge connectors with the first form factor which are configured to removably mate first power input socket 131 second edge connector sockets 102, whereas the other side of edge connector power cables 220 may have a form factor suitable to mate with first power input socket 231 (which may be an edge connector form factor in some examples or other form factor in other examples).

In this configuration, optionally second power input socket 232 may be connected to power outlet 104 using power cables 122. This may establish a secondary power supply path to the system board 230. In instances, power outlet 104 may be used to supplement power output provided through first edge connector socket 102. For example, in some implementations, second edge connector socket 106 may be a 73.5 mm M-CRPS socket, whereas the first edge connector socket 102 may be a 60 mm M-CRPS socket. As in this example the second edge connector socket 106 is capable of receiving a higher input from PSU 115 than the first edge connector socket 102 is capable of outputting, the power outlet 104 may be used for outputting the excess capacity received through second edge connector socket 106. It should be noted that if primary system board 130 does not require a power output above the capacity of the first edge connector socket 102, the power outlet 104 may be left unused. It should be noted that PSU 110 and PSU 115 are described with different numberings to better show the differing sizes of PSU that are connected in each configuration. For example, PSU 110 may be a 60 mm M-CRPS while PSU 115 may be a 73.5 M-CRPS. Because in the configuration shown in FIG. 2 power outlet 104 may be used to supplement power output, a higher power output PSU may likely to be used in this configuration. However, this description should only be used as examples and not interpreted as limiting the configurations to including a lower power output PSU in the configuration in reference to FIG. 1 and higher power output in reference to FIG. 2. Note that, in the second configuration illustrated in FIG. 2, the power outlet 104 can be connected to peripherals components in addition to, or in lieu of, being connected to the primary system board 230.

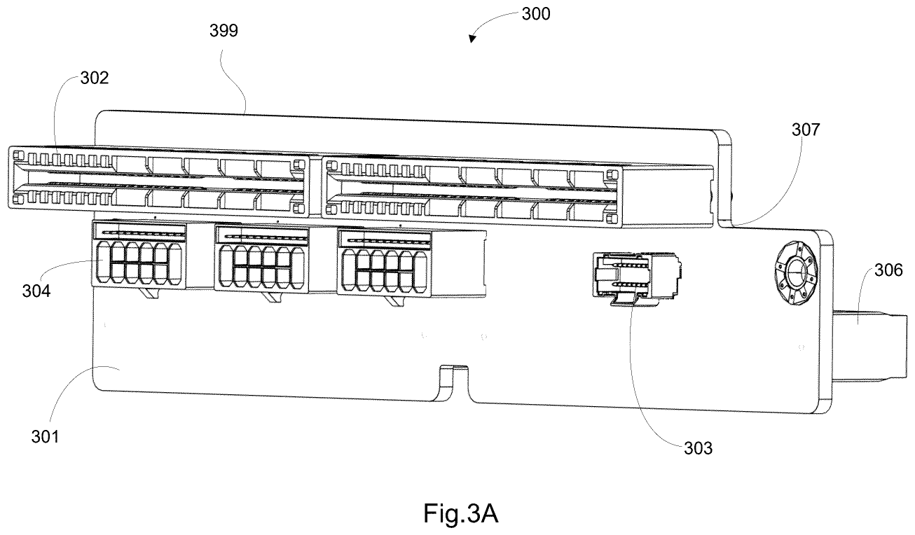

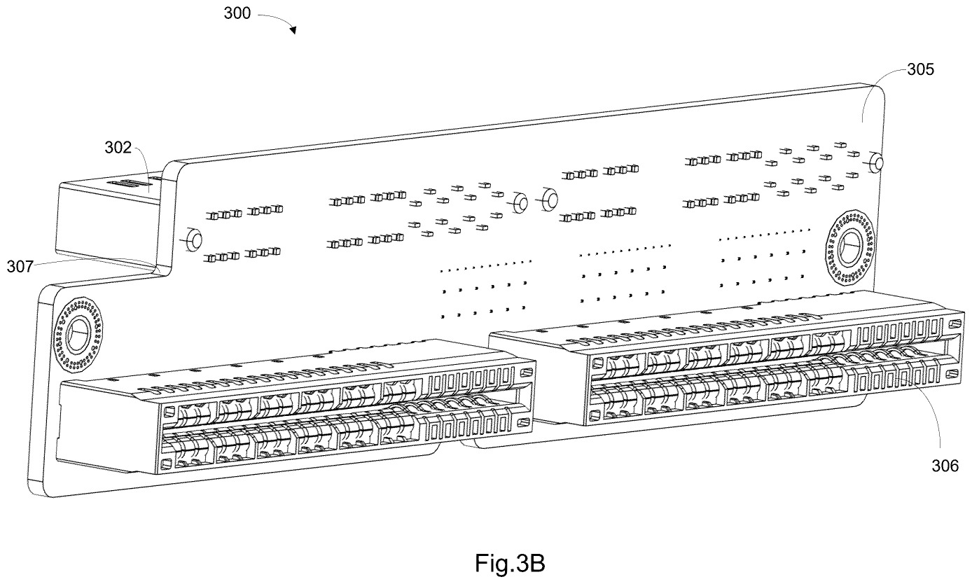

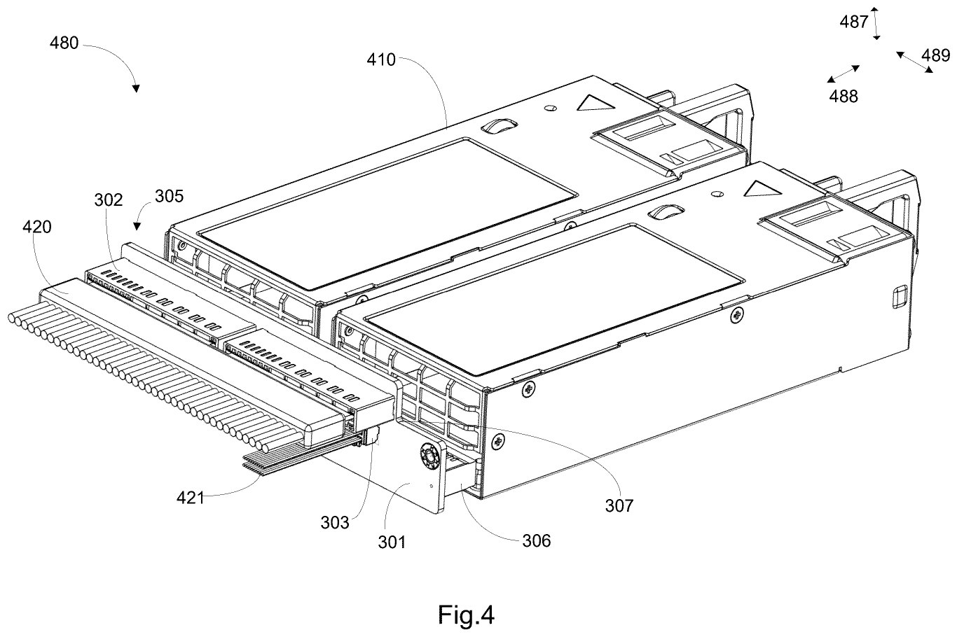

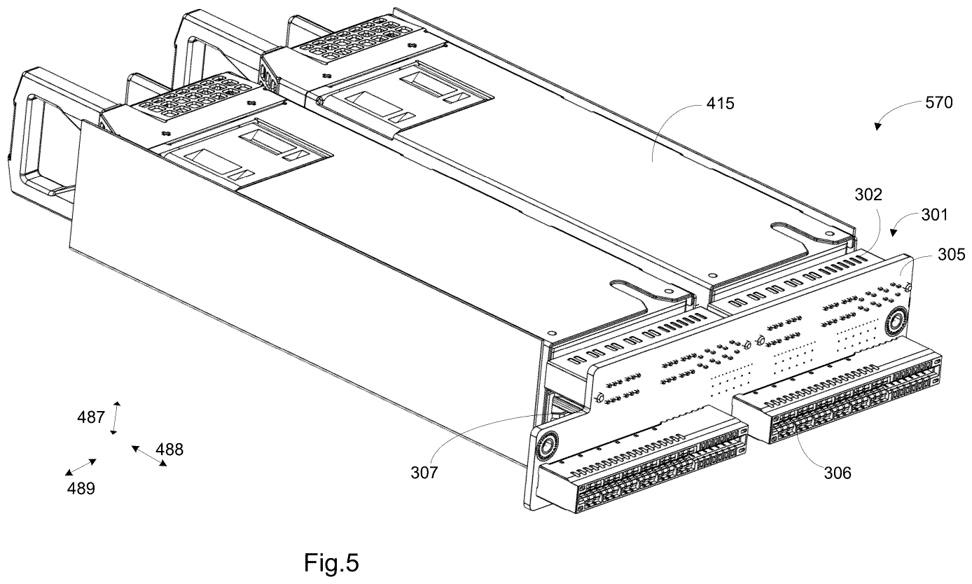

Now referring to FIGS. 3-5, an example of modular power transfer board 300 will be described, as well as various assemblies and systems which may include the modular power transfer board 300. The modular power transfer board 300 is illustrated in association with edge connector power cables 420, sideband cables 421 and example PSUs 410/415. FIGS. 3A and 3B show perspective views of a first side 301 and a second side 306, respectively, of modular power transfer board 300. FIG. 4 shows an assembly 480 of modular power transfer board 300, PSU 410, edge connector cables 420 and sideband cables 421, where PSU 410 is connected to second side 306 of modular power transfer board 300, and edge connector cables 420 and sideband cables 421 are connected to first side 301 of modular power transfer board 300. FIG. 5 shows an assembly 570 of modular power transfer board 300 and PSU 415, where PSU 415 is connected to first side 301 of power transfer board 300. The modular power transfer board 300 is described simultaneously with PSU 410, edge connector cables 420 and sideband cables 421, in FIG. 4, and simultaneously with PSU 415 in FIG. 5, for ease of understanding. However, it should be noted that modular power transfer board 300, edge connector power cables 420, sideband cables 421 and PSUs 410/415 may be produced or sold separately or together and may be claimed separately or together herein. The modular power transfer board 300 is an example implementation of modular power transfer board 100. Edge connector power cable 420 and sideband cables 421 are examples of edge connector power cables 120 and sideband cables 121, respectively. Example PSUs 410 and 415 are examples of PSU 110 and PSU 115, respectively. Elements in FIG. 3-5 and elements of FIGS. 1-2 whose reference numbers have the same last two digits as elements described above in relation to FIGS. 1 and 2, such as 102 and 302, correspond to one another, with elements in FIGS. 3-5 being one implementation example of the corresponding element in FIG. 1-2.

Elements in reference to FIGS. 4-5 are described using vertical 487, longitudinal 488 and latitudinal 489 directions for ease of description. However, it should be noted that these directional descriptions are used only relative to the position of the modular power transfer board 300. As such, for example, vertical position 487 could include a horizontal position relative to the ground, depending on the orientation of the modular power transfer board 300.

Modular power transfer board 300 includes a first side 301 and a second side 306. As mentioned above, first side and a second side are used for ease of description, and each refers to one face of a PCB 399 of the Modular power transfer board 300 together with the components mounted to that face.

In this example, as shown in FIG. 3A, the first side 301 includes two edge connector sockets 302, referred herein as first edge connector sockets 302 for ease of understanding. First side 301 also includes a sideband outlet 303 and three power outlets 304. As shown in FIG. 3B, example second side 305 includes two second edge connector sockets 306. Power pins of the sockets 302 are electrically connected to corresponding power pins of the sockets 306 via internal circuitry of the PCB.

Example modular power transfer board 300 includes a notch 307 in a corner of the PCB 399. As used herein, the notch 307 is used for allowing installation in a space constrained chassis. In instances, a section of a primary system board may sit within notch 307 in an installed position. That is, in some systems the space between an edge of the system board and a side wall of a chassis may be less than a width of the board 300 and therefore the board 300 would not be able to fit in that space without the notch 307, but with the notch 307 the board 300 may fit in the space. For example, the edge of the system board may sit within the notch allowing a portion of the board 300 to extend over system board. For example, modular power transfer board 300 may be installed in a 19″ chassis. Through the use of notch 307, the modular power transfer board 300 may be installed with a 295 mm primary system board. For example, a section of the primary system board may be aligned with the notch 307 during installation in a manner where the of both the modular power transfer board 300 and the primary system board can fit side by side since a portion of the primary system board occupies the space provided by the notch 307. It should be noted that in some configuration, such as where the space provided by the notch 307 is not needed, the notch 307 may be left unused.

Now referring to FIG. 4, the assembly configuration 480 is shown. In this configuration, a primary system board, or another device, removably mates with the modular power transfer board 300 through edge connector power cables 420 and sideband cables 421. Although not shown in this example, power outlet 304 is also available for connection to the primary system board, or another device. In this example, edge connectors of the edge connector power cables 420 are connected to the two first edge connector sockets 302 of the example modular power transfer board 300. In this example, the edge connectors of the edge connector power cables 420 are housed within a single casing. It should be noted that in other examples each of the edge connectors of the edge connector power cables 420 may be housed within separate casings. In this example, a sideband connector of sideband cables 421 is removably mated with the sideband outlet 103. The connector of sideband cables 421 and edge connectors of edge connector power cables 420 are moved towards the first side 301 of modular power transfer board 300, in the direction 488, until an electrical connection is made. Within the context of the sideband cables 421, the electrical connection also includes being communicatively connected to the modular power transfer board 300.

Continuing with the example of FIG. 4, the PSU edge connectors (not shown) of PSUs 410 are removably mated with the modular power transfer board 300 by moving each PSU 410 towards the second side 305 of modular power transfer board 300, in the direction 488, until PSUs 410 are communicably and electrically connected to modular power transfer board 300. In this example, the PSUs 410 and the primary system board or other device, not shown, are communicatively connected to each other upon the connections described are made.

Now referring to FIG. 5, in this example, the two PSUs 415 are removably mated with the modular power transfer board 300 by moving each PSU 415 toward the first side 301 of the modular power transfer board 300 until the PSUs 415 are communicatively connected to the first edge connector socket 301. Although the edge connector power cables 420 are omitted in this example, to complete the connection between the PSUs 415 and a primary system board, or another device, the edge connectors of the edge connector power cables are connected to edge connector 306, while the connectors of the sideband cable 421 are connected to the sideband outlet 303 of the first side 301. See FIG. 3B for the location of the sideband outlet 303 in this example. In this example, the PSUs 410 have a different size or form factor than PSUs 415. For example, PSUs 410 may be a 73.5 mm M-CRPS, while PSUs 415 may be a 60 mm M-CRPS. As noted above, in the configuration of FIG. 5, where the PSUS 415 connected to the first side 301, the power outlet 304 cannot be used due to it being physically blocked by the PSUs 415 in the installed position.

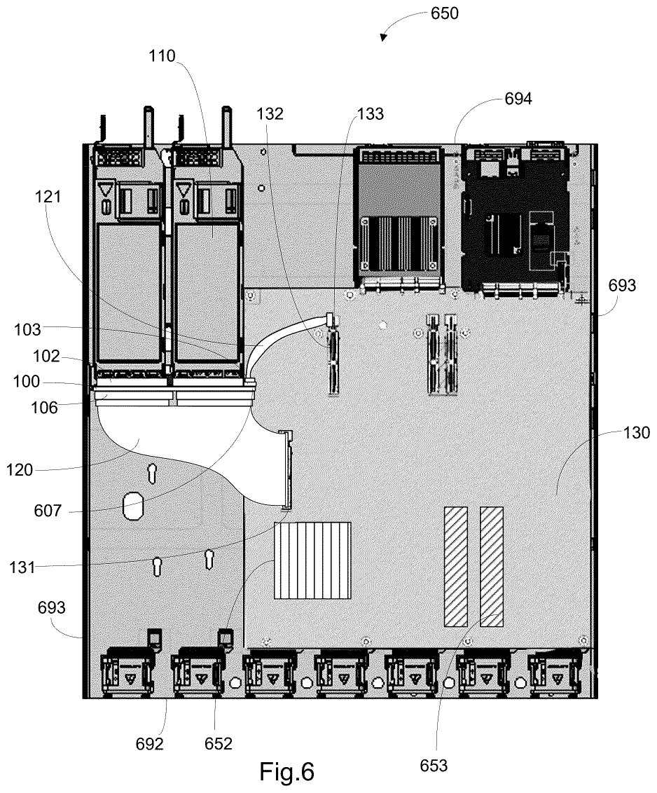

Now referring to FIG. 6, a computing system 650 is presented. In instances, computing system 650 includes a chassis. A “chassis,” as used herein, is an enclosure designed to house and support hardware components. The chassis includes a front panel 692, side panels 693 and a rear panel 694. The chassis also includes bottom and top panel, which are omitted for illustrative purposes.

In instances, computing device 600 includes the system board 130. In some instances, computing system 650 may include a processor 652 mounted to system board 140. As used herein, a “processor” is a component configured for executing instructions, performing calculations and managing tasks. In instances, computing system 650 may include two or more processors 652 mounted to system board 130. In an example, without limitations, processor 652 may be a Central Processing Unit, (CPU).

Still referring to FIG. 6, in instances, computing system 650 includes at least a memory 653 mounted to system board 140. As used in this disclosure, a “memory” is a data storage component configured to store instructions for a computing component, such as processor 652. In examples, without limitations, memory 653 may be configured for temporary storage of data, such as a random-access memory (RAM), or permanent data storage, such as Solid-State drives (SSD). In instances, processor 652 and/or memory 653 may communicate with each other via a bus. A “bus,” as used herein, is a component configured for transmitting data. The bus may include multiple types of bus structures, and combinations thereof, such as memory bus, memory controller, peripheral bus, local bus, and the like.

In instances, computing system 650 includes first power input socket 131 as part of primary system board 130. In instances, first power input socket 131 is configured to be removably attached to a connector of edge connector power cables 120 (not shown in FIG. 6). First power input socket 131 is configured to be electrically connected to modular power transfer board 100 using edge connector power cables 120. In instances computing system 650 includes sideband socket 133 as part of the primary system board 130. Sideband socket 133 are configured to be communicatively connected to modular power transfer board 100 through sideband cables 121. Although only first power input socket 131 and sideband socket 133 are illustrated in FIG. 6, other examples may be included in primary system board 130, such as second power input socket 132. As described throughout this disclosure, edge connector power cables 120, sideband cables 121 and power cables 122 include one end that connects to primary system board 130 and another end that connects to modular power transfer board 100.

In instances, computing system 650 includes modular power transfer board 100. In instances, modular power transfer board 100 may be attached to side panel 693. In this example, computing system 650 also includes two PSUs 110. Modular power transfer board 100 includes two first edge connector sockets 102 and two second edge connector sockets 106 and a sideband outlet 103. In this example, the two first edge connector sockets 102 connected to the two PSUs 110 and the two second edge connector sockets 106 connects to first power input socket 131 using edge connector power cables 120.

In instances, the two PSUs 110 may be attached to a PSU cage. PSU cage may be a metal enclosure configured to house the PSUs 110. In instances, the PSU cage may be attached to the rear panel 694. In instances, modular power transfer board 100 may be attached to the PSU cage. Modular power transfer board 100 may be attached to side panel 693 or PSU cage using attachment features, such as fasteners, such as screws, snap-fit connectors, plastic rivets, push pins, and the like. As described through this disclosure, PSUs 110 and primary system board 130 are connected by removably attaching PSUs 110 to modular power transfer board 100 and primary system board 130 to modular power transfer board 100 through edge connector cables, sideband cables and/or power cables.

In instances, a method is presented. The method includes connecting a modular power transfer board to a PSU. The modular power transfer board and PSU may be the same as modular power transfer board 100 and PSU 110/115, respectively. The method includes inserting a PSU edge connector of the PSU into one of a first edge connector socket of a first side of the modular power transfer board or a second edge connector socket of a second side of the modular power transfer board. The method may further include inserting a first side of a sideband cable into a sideband outlet of the modular power transfer board and a second side of the sideband power cable into a sideband socket of the primary system board. Sideband outlet, sideband cable and sideband socket may be the same as sideband outlet 103, sideband cable 121 and sideband socket 133.

The method further includes connecting the modular power transfer board to a primary system board. The primary system board may include primary system board 130. The method includes inserting a power connector of an edge connector power cable mated with the primary system board onto the other or the first edge connector socket of the first side of the modular power transfer board or the second edge connector socket of the second side of the modular power transfer board. The edge connector power cable may be the same as edge connector power cable 120. The method may further include inserting a first end of a power cable into a power socket of the primary system board and inserting a second end of the power cable into a power outlet of the modular power transfer board. Power socket, power cable and power outlet may be the same as second power input socket 132, power cables 122 and power outlet 104.

In instances the method may further include placing a notch of the modular power transfer board under a portion of the primary system board and inserting the modular power transfer board into a chassis housing the primary system board. The notch may be similar to, or the same as, notch 307 and 607 described further above.

In the description above, various types of electronic circuitry are described. As used herein, “electronic” is intended to be understood broadly to include all types of circuitry utilizing electricity, including digital and analog circuitry, direct current (DC) and alternating current (AC) circuitry, and circuitry for converting electricity into another form of energy and circuitry for using electricity to perform other functions. In other words, as used herein there is no distinction between “electronic” circuitry and “electrical” circuitry.

It is to be understood that both the general description and the detailed description provide examples that are explanatory in nature and are intended to provide an understanding of the present disclosure without limiting the scope of the present disclosure. Various mechanical, compositional, structural, electronic, and operational changes may be made without departing from the scope of this description and the claims. In some instances, well-known circuits, structures, and techniques have not been shown or described in detail in order not to obscure the examples. Like numbers in two or more figures represent the same or similar elements.

In addition, the singular forms “a”, “an”, and “the” are intended to include the plural forms as well, unless the context indicates otherwise. Moreover, the terms “comprises”, “comprising”, “includes”, and the like specify the presence of stated features, steps, operations, elements, and/or components but do not preclude the presence or addition of one or more other features, steps, operations, elements, components, and/or groups. Components described as coupled may be electronically or mechanically directly coupled, or they may be indirectly coupled via one or more intermediate components, unless specifically noted otherwise. Mathematical and geometric terms are not necessarily intended to be used in accordance with their strict definitions unless the context of the description indicates otherwise, because a person having ordinary skill in the art would understand that, for example, a substantially similar element that functions in a substantially similar way could easily fall within the scope of a descriptive term even though the term also has a strict definition.

And/or: Occasionally the phrase “and/or” is used herein in conjunction with a list of items. This phrase means that any combination of items in the list—from a single item to all of the items and any permutation in between—may be included. Thus, for example, “A, B, and/or C” means “one of {A}, {B}, {C}, {A, B}, {A, C}, {C, B}, and {A, C, B}”.

Elements and their associated aspects that are described in detail with reference to one example may, whenever practical, be included in other examples in which they are not specifically shown or described. For example, if an element is described in detail with reference to one example and is not described with reference to a second example, the element may nevertheless be claimed as included in the second example.

Unless otherwise noted herein or implied by the context, when terms of approximation such as “substantially,” “approximately,” “about,” “around,” “roughly,” and the like, are used, this should be understood as meaning that mathematical exactitude is not required and that instead a range of variation is being referred to that includes but is not strictly limited to the stated value, property, or relationship. In particular, in addition to any ranges explicitly stated herein (if any), the range of variation implied by the usage of such a term of approximation includes at least any inconsequential variations and also those variations that are typical in the relevant art for the type of item in question due to manufacturing or other tolerances. In any case, the range of variation may include at least values that are within ±1% of the stated value, property, or relationship unless indicated otherwise.

Further modifications and alternative examples will be apparent to those of ordinary skill in the art in view of the disclosure herein. For example, the devices and methods may include additional components or steps that were omitted from the diagrams and description for clarity of operation. Accordingly, this description is to be construed as illustrative only and is for the purpose of teaching those skilled in the art the general manner of carrying out the present teachings. It is to be understood that the various examples shown and described herein are to be taken as exemplary. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the scope of the present teachings and following claims.

It is to be understood that the particular examples set forth herein are non-limiting, and modifications to structure, dimensions, materials, and methodologies may be made without departing from the scope of the present teachings.

Other examples in accordance with the present disclosure will be apparent to those skilled in the art from consideration of the specification and practice of the invention disclosed herein. It is intended that the specification and examples be considered as exemplary only, with the following claims being entitled to their fullest breadth, including equivalents, under the applicable law.

What is claimed is:

1. A modular power transfer board comprising:
a first side comprising a first edge connector socket; and
a second side comprising a second edge connector socket,
wherein the first edge connector socket and the second edge connector socket are electrically connected to each other, and
wherein:
in a first configuration, the first edge connector socket is configured to connect to a power supply unit (PSU) edge connector of a PSU and the second edge connector socket is configured to connect to a first power input socket of a primary system board via an edge connector power cable; and
in a second configuration, the first edge connector socket is configured to connect to the board edge connector of the primary system board and the second edge connector socket is configured to connect to a second PSU edge connector of a second PSU via a second edge connector power cable.

2. The modular power transfer board of claim 1, wherein the first side further comprises a sideband outlet configured to connect with a board sideband socket of the primary system board via a sideband cable.

3. The modular power transfer board of claim 1, wherein the first side further comprises a power outlet.

4. The modular power transfer board of claim 3, wherein in the second configuration, the power outlet is configured to connect to a second power input socket via a power cable.

5. The modular power transfer board of claim 1, further comprising a notch.

6. The modular power transfer board of claim 1, wherein one of the first edge connector socket and the second edge connector socket is configured to connect to a Modular Common Redundant Power Supply (M-CRPS) 60 mm form factor edge connector, and the other of the first edge connector socket and the second edge connector socket is configured to connect to an M-CRPS 73.5 mm form factor edge connector.

7. The modular power transfer board of claim 1, wherein the first side comprises a plurality of first edge connector sockets including the first edge connector socket, wherein in the first configuration each of the first edge connector sockets is configured to connect to a PSU edge connector of a respectively corresponding PSU and in the second configuration each of the first edge connector sockets is configured to connect with a corresponding power input socket of the primary system board.

8. The modular power transfer board of claim 1, wherein the second side comprises a plurality of second edge connector sockets including the second edge connector socket, wherein in the first configuration each of the second edge connector sockets is configured to connect with a corresponding power input socket of the primary system board and in the second configuration the each of the second edge connector socket is configured to connect to a corresponding PSU edge connector of the second PSU.

9. A computing system, comprising:
a chassis comprising a base and a back panel;
a system board supported by the base, wherein the system board comprises one or more board edge connector sockets;
a power supply unit (PSU) supported by the chassis and comprising a PSU edge connector;
a power cable comprising a first connector, a second connector, and wires extending between the first and second connectors, wherein the second connector is mated with one of the board edge connector sockets;
a modular power transfer board comprising:
a first side comprising a first edge connector socket; and
a second side comprising a second edge connector socket,
wherein the first edge connector socket and the second edge connector socket are electrically connected to each other,
wherein the first edge connector socket is connected to the PSU edge connector and the second edge connector socket is connected to the first connector of the power cable, and
wherein the system is reconfigurable into a second configuration in which: a second PSU replaces the PSU, a second power cable replaces the power cable, the first edge connector socket is connected to a first connector of the second power cable, and the second edge connector socket is connected to a PSU edge connector of the second PSU.

10. The system of claim 9, wherein the first side comprises a sideband outlet and the system board comprises sideband socket.

11. The system of claim 10, further comprising a sideband cable and wherein the sideband cable is configured to connect the sideband outlet to the sideband socket.

12. The system of claim 9, wherein the system board further comprises board power sockets.

13. The system of claim 12, wherein the first side comprises a power outlet and wherein the power outlet is configured to connect with one of the board power sockets.

14. The system of claim 9, wherein the modular power transfer board comprises a notch receive a portion of the system board as to facilitate insertion into the chassis.

15. The system of claim 9, wherein the modular power transfer board is disposed in a space between a side edge of the system board and a side wall of the chassis, and a width of the space is less than a width of the modular power transfer board.

16. The system of claim 9, wherein with the system board has a Modular Software-Defined Network Orchestration (M-SDNO) type 4 from factor.

17. A method comprising:
connecting a modular power transfer board to a power supply unit (PSU) by:
inserting a PSU edge connector of the PSU into one of a first edge connector socket of a first side of the modular power transfer board or a second edge connector socket of a second side of the modular power transfer board; and
connecting the modular power transfer board to a primary system board by:
inserting a power connector of an edge connector power cable mated with the primary system board into the other of the first edge connector socket of the first side of the modular power transfer board or the second edge connector socket of the second side of the modular power transfer board.

18. The method of claim 17, further comprising inserting a first side of a sideband cable into a sideband outlet of the modular power transfer board and a second side of the sideband cable into a sideband socket of the primary system board.

19. The method of claim 17, further comprising inserting a first end of a power cable into a power socket of the primary system board and inserting a second end of the power cable into a power outlet of the modular power transfer board.

20. The method of claim 17, further comprising:
placing a notch of the modular power transfer board under a portion of the primary system board; and
inserting the modular power transfer board into a chassis housing the primary system board.
